(19) United States
(12) Patent Application Publication
(10) Pub. No.: US 2022/0405707 A1
(43) Pub. Date: Dec. 22, 2022

(54) SYSTEM AND METHOD TO PREPARE A STANDARDIZED TRANSFER DOCUMENT FOR TRANSPORTATION OF A MATERIAL

(71) Applicants: Mark Childerson, TORONTO (CA); Vlad Mandrychenko, TORONTO (CA); Rob Bowd, TORONTO (CA); Gerrome Tan, TORONTO ON (CA)

(72) Inventors: Mark Childerson, TORONTO (CA); Vlad Mandrychenko, TORONTO (CA); Rob Bowd, TORONTO (CA); Gerrome Tan, TORONTO ON (CA)

(21) Appl. No.: 17/890,401

(22) Filed: Aug. 18, 2022

Related U.S. Application Data
(60) Provisional application No. 63/294,169, filed on Dec. 28, 2021.

(51) Int. Cl. G06Q 10/08; G06F 40/186; G06F 40/12

(52) U.S. Cl. CPC G06Q 10/0875; G06F 40/186; G06F 40/12

(57) ABSTRACT

The present invention relates preparation of standardized transfer document for transportation of a material. The method may include; acquiring, from a computing device through a buyer, a recipient detail and an order detail to indicate intent of purchase of the material; transmitting, the acquired recipient detail and the acquired order detail to a computing machine, which is accessible by a supplier; receiving, from the computing machine, a transfer request from the supplier, wherein the transfer request comprises the received recipient detail, the received order detail; and an information of a carrier; receiving, a departure status from the carrier; generating a quick response (QR) code, based on the received transfer request; preparing a standardized transfer document for transportation of the material, wherein the standardized transfer document is associated with the generated QR code.

### FIELD OF THE INVENTION

The present invention relates generally to supply chain management, more particularly, to prepare a standardized transfer document for transportation of a material.

### BACKGROUND

The background description includes information that may be useful in understanding the present invention. It is not an admission that any of the information provided herein is prior art or relevant to the presently claimed invention, or that any publication specifically or implicitly referenced is prior art.

The shipping sector is generally made up of three types of carriers, each of which provides services to meet different consumer requirements. Tiny package carriers such as Federal Express, United Parcel Service, and others collect small packages, aggregate them into large loads, transport them close to their destination, and then deliver them. Large customers who fill trucks or trailer loads, often known as truck load shippers, are on the other extreme of the shipping spectrum. Less-than-truckload (LTL) carriers are between truckload shippers and small package shippers. The less-than-truckload (LTL) carrier receives freight from different customers, similar to how a logistic partner collects and delivers many small products during a business day. This freight is usually bound for a variety of destinations around the country. The freight is returned to a terminal, where it is unloaded from the vehicle, consolidated with other freight traveling in the same direction, and reloaded into delivery trucks. At the terminal, the freight is sorted and consolidated into truck loads to reduce the amount of vacant space on the vehicle that will take it from the local terminal to a local delivery or distribution terminal in another city or state. The truck will be unloaded at the distribution terminal, and its freight will be restored and reconsolidated for delivery to clients in the immediate region or shipment to another distribution terminal.

Each shipment is governed by its own contract, known as a “bill of lading.” Customers frequently have their own bill of lading form that they use to ship their goods. A truck driver may collect numerous distinct bills of lading forms during the course of a day, one for each cargo. Furthermore, as the driver delivers shipments, he or she will supply and generate a large number of delivery receipts. Throughout the day, the driver deals with a variety of different documents, such as customs documents and the like.

Customer service, like any other business, is judged on efficiency and quickness. A trucking or other carrier's competitive advantage is determined by the speed and efficiency of these activities. A truck driver will usually leave the truck terminal early in the morning and return late at night. When he returns, he has a hand full of bill of lading forms and other documentation, which he submits to the corporate office, where it is processed by data entry clerks. The shipping information is transferred to the loading dock at the terminal after the information from each bill of lading is entered, allowing the freight traveling to common destinations to be combined and the delivery schedule to be planned.

The purpose of proper load planning is to deliver the freight on schedule and with a full load on the delivery truck, when truck leaves the terminal. Unfortunately, while the data entry and load planning operations are being conducted in systems, the truck used to pick up and transport the freight are often lying idle at the terminal.

Generally, freight is normally delivered as one truck at a time, whereas the loading dock may not be aware of the other trucks arriving at the terminal. Moreover, the dock is also not aware about the contents and destination of the freight picked up on any particular day. As a result, partially loaded trucks leave the terminal. Many of these partially loaded trucks could have been completely filled, if the load planner had been aware of unplanned freight that had been picked up and would be arriving at the terminal soon. Partially moving freight results in poor efficiency, higher costs, and lower earnings for the trucking company.

The existing systems functionality is limited to only scan and transmission of documents. Some systems, demand manual operator for entry of the document type and data association. Furthermore, standard existing systems are unable to assist the driver in ensuring that all data is delivered, and papers are scanned accurately. Furthermore, while some systems can scan and transmit images, the connection of data with the images necessitates a large amount of manual effort. Additionally, such systems usually do not track or provide information about the trailer that are being carried. As a result, improvements in the efficiency and capability of freight carrier document transmission and processing systems are sought.

However, the technological solutions for preparation of a standardized document for transportation of a material suffers from various aforementioned limitations. Thus, there remains a need for further contributions in this area of technology. More specifically, a need exists in the area of technology to prepare a standardized transfer document for transportation of a material.

All references, including publications, patent applications, and patents, cited herein are hereby incorporated by reference to the same extent as if each reference were individually and specifically indicated to be incorporated by reference and were set forth in its entirety herein.

### SUMMARY

The present invention relates generally to supply chain management, more particularly, to prepare a standardized transfer document for transportation of a material.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The following paragraphs provide additional support for the claims of the subject application.

In an aspect the present disclosure provides a system to prepare a standardized transfer document for transportation of a material, the system comprises: a server arrangement comprising: a non-transitory storage device that is arranged to store a set of executable routines; and a microprocessor which is coupled to the non-transitory storage device and operable to execute the set of routines to: acquire, from a computing device through a buyer, a recipient detail and an order detail to indicate intent of purchase of the material; transmit, the acquired recipient detail and the acquired order detail to a computing machine, which is accessible by a supplier; receive, from the computing machine, a transfer request from the supplier, wherein the transfer request comprises: the received recipient detail; the received order detail; and an information of a carrier; receive, a departure status from the carrier; generate a quick response (QR) code, based on the received transfer request; and prepare a standardized transfer document for transportation of the material, wherein the standardized transfer document is associated with the generated QR code.

In another aspect the present disclosure provides a method for preparing a standardized transfer document for transportation of a material, the method comprises: arranging a server arrangement for: acquiring, from a computing device through a buyer, a recipient detail and an order detail to indicate intent of purchase of the material; transmitting, the acquired recipient detail and the acquired order detail to a computing machine, which is accessible by a supplier; receiving, from the computing machine, a transfer request from the supplier, wherein the transfer request comprises: the received recipient detail; the received order detail; and an information of a carrier; receiving, a departure status from the carrier; generating a quick response (QR) code, based on the received transfer request; and preparing a standardized transfer document for transportation of the material, wherein the standardized transfer document is associated with the generated QR code.

In an embodiment, the server arrangement transmits the received departure status on the computing device.

In an embodiment, the server arrangement displays an expected date of delivery of the material on the computing device, based on the received departure status and the received recipient detail.

In an embodiment, the server arrangement transmits the standardized transfer document and a corresponding QR code on the computing device.

In an embodiment, the server arrangement transmits a payment link within the transmitted standardized transfer document.

In an embodiment, the computing device receives a delivery update status from the buyer, upon delivery of the material.

In an embodiment, the server arrangement acquires the delivery update status from the computing device and updates the acquired delivery update status within the standardized transfer document.

### BRIEF DESCRIPTION OF THE DRAWINGS

Embodiments will now be described in more detail in relation to the enclosed drawings, in which:

FIG. 1 illustrates an architecture to prepare a standardized transfer document for transportation of a material and components/elements thereof, in accordance to embodiment of present disclosure.

FIG. 2 illustrates exemplary functional unit to prepare a standardized transfer document for transportation of a material, in accordance with embodiments of the present disclosure.

FIG. 3 illustrate exemplarily steps to prepare a standardized transfer document for transportation of a material, in accordance with embodiments of the present disclosure.

FIG. 4 illustrates an exemplary transfer document, in accordance to embodiment of the present disclosure.

### DETAILED DESCRIPTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The present invention relates generally to supply chain management, more particularly, to prepare a standardized transfer document for transportation of a material.

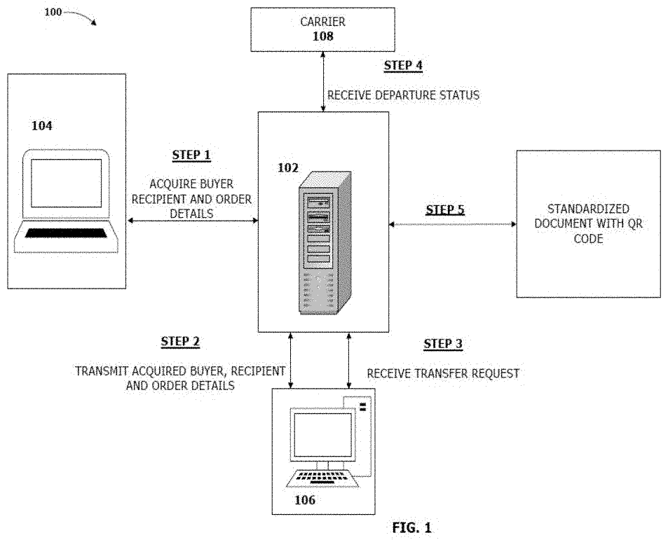

Referring now to the invention in more detail, in FIG. 1 there is shown an architecture 100 to prepare a standardized transfer document for transportation of a material and components/elements thereof, in accordance to embodiment of present disclosure. Referring now to the invention in more detail, in FIG. 1 there is shown a server arrangement 102, a computing device 104, a computing machine/terminal 106 and a carrier 108 and other known components of cyber security platform. Data communication enables communication among different components or external computing environment, and an electrical energy source to provide electrical energy to the one or more components of system architecture 100. It can be appreciated that the aforementioned components are communicably coupled with each other. The term material may include a digital content (e.g., an electronic game, movie, photos and videos) and a physical item such as garment, electronic good, chemical substance, pharmaceutical product, cosmetic item, food item, petrochemical substance, toy, baby product, furniture item, automobile and parts thereof, jewelry item, books, sports or fitness goods, home decor item, personal appeal item and any other item sold on e-commerce platform.

In an embodiment, at STEP 1, the server arrangement 102 can be arranged to acquire a recipient detail and an order detail from a buyer (through computing device 104 such as smartphone, laptop etc.), to indicate intent of purchase of the material in an online mode. The recipient detail may comprise payment details (e.g., mode of payment, payment currency etc.), a demographic datils of recipient (e.g., name, gender, etc.), contact details (e.g., delivery address, landmark), a delivery related information (e.g., delivery time slot, drop-off direction, preferred date/day of delivery), mode of transient (e.g., ship through air or by road), handling direction (e.g., ship through cold storage, protect from light etc.), seller information (e.g., preferred seller, seller location etc.), an address of the buyer/ recipient who may place an order (for himself or for other individual) for purchase of the material through server arrangement 102. The recipient detail can also be the name and address of a person (other than buyer) who may be recipient of the material as a gift item. The computing device 104 may comprise the order detail which may refer to a quantity of the material being ordered through server arrangement 102. The server arrangement 102 can generate a unique identifiable code (UIC) based on the recipient detail and order detail. The UIC can act as single descriptor, which can be used to ease documentation for material movements and transfers. The UIC, recipient detail and order detail can be communicated to computing machine 104 (which can be accessed by supplier/warehouser/seller).

In an embodiment, at STEP 2, the server arrangement 102 may transmit, the acquired recipient detail and the acquired order detail (in form of UIC or other suitable format) to the computing machine 106, which can be accessible by a supplier, seller, logistic partner, moderator/administrator and other relevant parties who are associated with transient of the material. The computing device 104 or computing terminal 104, can be selected from a mobile phone, a tablet phone, a desktop computer, a laptop, or known computing instrument.

In an embodiment, at STEP 3, the computing machine 106 can be configured to transmit request to server arrangement 102. The seller may raise query to computing machine 104 to determine a list of materials that is ready to ship, a list of materials require packaging, a list of materials which are not currently in adequate stock to enable order fulfillment to ship the ordered material at destination location based on received UIC, which comprising details of recipient and order. Further, the computing machine 104 may receive a transfer request from the supplier. The transfer request may comprise a location of contractor, a logistic information (e.g., shipping charges, proffered logistic partner), recipient detail, UIC, order detail, a priority list to handle order, packaging instruction and other related information. The transfer request may also comprise an information of the carrier 106, who may pick the material from a location of the supplier and may drop the picked material at the address of the recipient mentioned within the recipient detail. The carrier 106 can be arranged to pick up the material from location of supplier and carry the picked material for delivering it at recipient's location, where the recipient could receive the delivered material.

In an aspect, at STEP 4, carrier 106 may trigger a departure status (through a second computing device), upon pick up of the material from location of the seller. The departure status would provide confirmation that material had left seller's facility and transit journey is commenced. The second computing device comprises a GPS sensor, which provide current location of the carrier (thereby real time location of material during transit), wherein the current location may assist stakeholders to monitor real time progress of delivery of the material. Further, GPS sensor also improves reliability and security aspect of material handling during transit, that also further enables tracking of lost material or wrong delivery of material.

The carrier 106 may provide input about delivery of material at intended destination, confirm material delivery to recipient, detail about receiving person, delivery pass-code to confirm delivery to recipient, non-availability of recipient or agent thereof, image to confirm delivery of material and other relevant information that can be used to confirm delivery. A corporation or a person with legal authority to carry material by land, sea, or air is known as carrier 106. Typically, the carrier 106 will collaborate with the supplier to transport the material from one location to another. The carrier 106 can be selected from a common carrier or a contract carrier, wherein the common carrier refers to a transport provider who is authorized to provide services to any individual or company under the terms of a regulatory body's license. On the other hand, contract carrier refers to a corporation or someone who provides transportation services for shipping. This means that the contract carrier and the supplier come to an agreement and agree to work under specified circumstances for the duration of the contract.

In another aspect, at STEP 5, the server arrangement 102 could acquire departure status from carrier 106 and generate a quick response (QR) code, which can be used to track the movement of material or enable tracking of history of material movement. Further, the server arrangement 102 may be arranged to receive destination arrival status from the second computing device in a run-time manner through known communication means.

Further, the server arrangement 102 may generate a standardized transfer document based on the received recipient detail, order detail and transfer request, wherein the standardized transfer document can be utilized by recipient of the material for tracking a current transportation status of the material. The server arrangement 102 may comprise a non-transitory storage device and a microprocessor.

In an embodiment, the non-transitory storage device can be arranged to store a set of routines which can be executed by the microprocessor to prepare a standardized transfer document for transportation of a material. The non-transitory storage device can be a flash drive, RAM or other known types of electronic data storage devices.

In an embodiment, the microprocessor can enable establishment of a communication between the buyer, supplier and the carrier 106 to streamline purchase and delivery of the purchased product. The microprocessor may acquire from the computing device 104 through the buyer, the recipient detail and the order detail to indicate intent of purchase of material, wherein the recipient detail may comprise the name and the address of the recipient who may receive the delivery of the material. The microprocessor may transmit, the acquired recipient detail and the acquired order detail to the computing machine 104, which can be accessible by the supplier who may supply ordered material in desired quantity to the recipient. The microprocessor may receive, from the computing machine 104, a transfer request which may exemplary comprise the received recipient detail (name and address of recipient), the received order detail (such as material and quantity of material), the information of the carrier 106. The microprocessor may receive, a departure status from the carrier 106, wherein the departure status may indicate that the material has been shipped for being delivered at the delivery location. The microprocessor may associate a quick response (QR) code, based on the received transfer request, wherein the QR code can be scanned to gather the current transportation status of the material or history of previous location. The microprocessor may prepare standardized transfer document for transportation of the material, wherein the standardized transfer document is associated with the generated QR code which can be scanned to gather the departure status and current transportation status (arrival of material and departure of material at multiple sub-stations between the location of the supplier and the address of recipient).

In an embodiment, the server arrangement 102 may transmit the received departure status on the computing device 104 so that recipient may get aware that the material has been departed (shipped) from the location of supplier. The departed material can be delivered at the address of recipient within a pre-set duration.

In an embodiment, the server arrangement 102 may calculate an expected date of delivery of the material and also determine any deviation on scheduled delivery time frame. The expected date of delivery may be communicated to stakeholders to provide update during transit of material. The expected date of delivery could provide a tentative idea that after how many days the material will be delivered at the address of recipient.

In an embodiment, the server arrangement 102 may transmit the standardized transfer document and a corresponding QR code on the computing device 104, wherein the QR code can be scanned using a scanning application (which can be pre-installed at computing device 104). The QR code when scanned, may depict the current transportation status and/or histological movement information of the material.

In an embodiment, the server arrangement 102 may generate and transmit a payment link with the standardized transfer document, thereby providing a convenient way of making payment against the purchased material. Alternatively, the payment link would be provided at time of receiving intent of purchase. When payment link is clicked by recipient, payment options can be depicted on the computing device 104, wherein the payment option can be selected based on choice of recipient.

In an embodiment, the computing device 104 may receive a delivery update status from the buyer (who can be the recipient of the material), upon delivery of the material at the address of recipient. The received delivery update status can be appended within the standardized transfer document, indicating that the material has reached at intended address.

In an embodiment, the server arrangement 102 may acquire the delivery update status from the computing device 104 and updates the acquired delivery update status within the standardized transfer document, thereby indicating that the material has reached at the address of recipient. The standardized transfer document can be stored in non-transitory storage device for a pre-set time duration for future reference. Such duration can be few hours, days, weeks, months or years.

In an alternate embodiment, the present disclosure describes a multi-pronged technique for providing standardized transfer document, which can be utilized in accurate tracking of the current transportation status of the material. By providing a QR code, the present invention provides an efficient system for tracking the current transportation of the material (increasing the ease of opening sub-sections of an application for tracking the current transportation status of the material). The present disclosure can send an alert notification to the computing device 104 informing the buyer of the current transportation status of the material. Non-limiting examples of notifications can be a multimedia message, a text message, a light blink, and the like.

In an embodiment, the present disclosure can be implemented as a web-based model that can be flexible enough to represent a lifecycle of the material/item that can be shipped in the complex supply chain. The web-based system incorporates a common data source to enable coordination of multiple internal/external data inputs through a common platform that is readily accessible by plethora of users. Additionally, the web-based model amplifies visibility of all relevant materials at all promising locations for appropriate stakeholders, including hand-offs of materials between stakeholders. Further, an automation of work processes such as triggering of automated alerts/notifications (e.g., SMS, electronic messages, instant messenger message, audio signal, multimedia data, and the like) based on defined business rules and auto-expediting workflows can be performed. Moreover, tracking of milestone (example—historical information) updates and timing of such updates over time uplifts overall quality of material handling data. Real time reports can be provided to simplify information gathering and provide material inventory status. Further, the system delivers pre-defined & flexible reports along with data exports for higher-end analytics. Moreover, a third-party performance management can be even provided by the web-based system.

In an embodiment, the present disclosure enables unlimited number of use cases such as simultaneously tracking of shipments by multiple users. The disclosure enables efficient management of entire life cycle of supply chain management such as tracking part generation, manufacturing, shipment, inventory, installation and disposal.

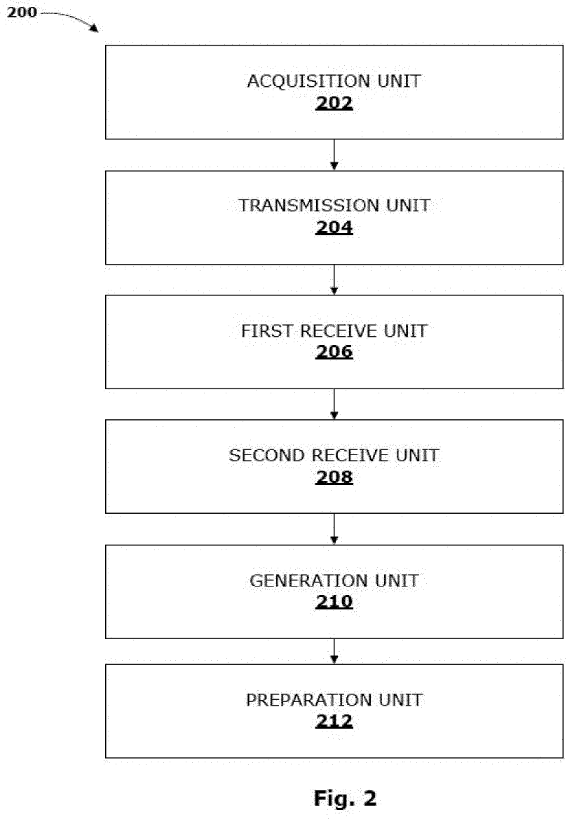

FIG. 2 illustrates exemplary functional unit 200 to prepare a standardized transfer document for transportation of a material, in accordance with embodiments of the present disclosure. As illustrated, the functional unit 200 can comprise an acquisition unit 202, a transmission unit 204, a first receive unit 206, a second receive unit 208, a generation unit 210 and a preparation unit 212. The functional unit 200 can be executed by the microprocessor.

In an embodiment, the acquisition unit 202 can be configured to acquire, from computing device 104, a recipient detail and an order detail to indicate intent of purchase of the material, in a run-time or near run-time manner through known communication means (e.g., WIFI, telecommunication network).

In an embodiment, the transmission unit 204 can be configured to transmit, the acquired recipient detail and the acquired order detail to the computing machine 104, which can be accessible by the supplier who may be an authorized seller of the ordered material. The supplier may provide the material in the desired quantity to the recipient. The transfer request may comprise UIC, information about carrier (e.g., mode of transfer), handling instruction (e.g., glass item, electronic item with battery, biological material transfer in cold condition etc.), and other relevant information.

In an embodiment, the first receive unit 206 can be configured to receive from the computing machine 104, a transfer request which may comprise the received recipient detail (name and address of recipient), the received order detail (the material and quantity of the material), the information of the carrier 106, which may transport the material from location of the supplier to the address of recipient.

In an embodiment, the second receive unit 208 can be configured to receive, a departure status from the carrier 106, wherein the departure status may indicate that the material left warehouse or storage facility at which material was stored. The departure status would provide valuable information to system administrator (about initiation of product delivery cycle, about non-fulfillment of order, any delay of material deliver etc.), buyer, account team (to release payment to seller or courier partner).

In an embodiment, the generation unit 210 can be configured to generate the QR code, based on the received transfer request, wherein the QR code can be scanned to gather the current transportation status of the material, being supplied by the supplier in the quantity desired.

In an embodiment, the preparation unit 212 can be configured to prepare a standardized transfer document for transportation of the material, wherein the standardized transfer document can be associated with the generated QR code, which can be scanned for gathering the current transportation status of the material.

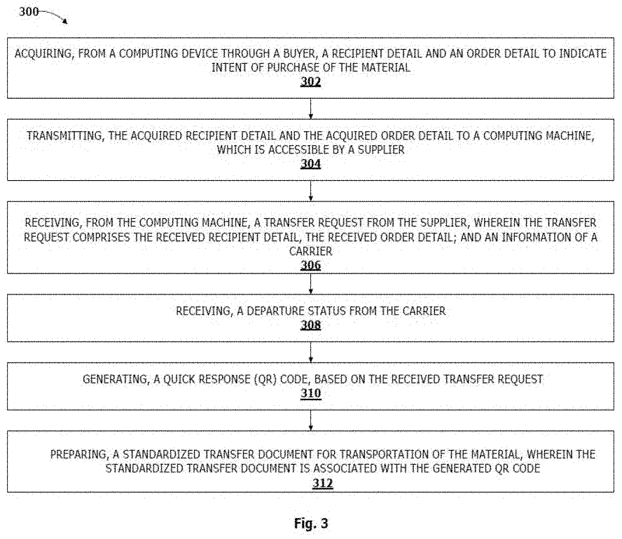

FIG. 3 illustrate exemplarily steps to prepare a standardized transfer document for transportation of a material, in accordance with embodiments of the present disclosure. As illustrated in flow diagram 300, the method may include steps of: at step (302) acquiring, from a computing device through a buyer, a recipient detail and an order detail to indicate intent of purchase of the material; at step (304) transmitting, the acquired recipient detail and the acquired order detail to a computing machine, which is accessible by a supplier; at step (306) receiving, from the computing machine, a transfer request from the supplier, wherein the transfer request comprises the received recipient detail, the received order detail; and an information of a carrier; at step (308) receiving, a departure status from the carrier; at step (310) generating a quick response (QR) code, based on the received transfer request; at step (312) preparing a standardized transfer document for transportation of the material, wherein the standardized transfer document is associated with the generated QR code.

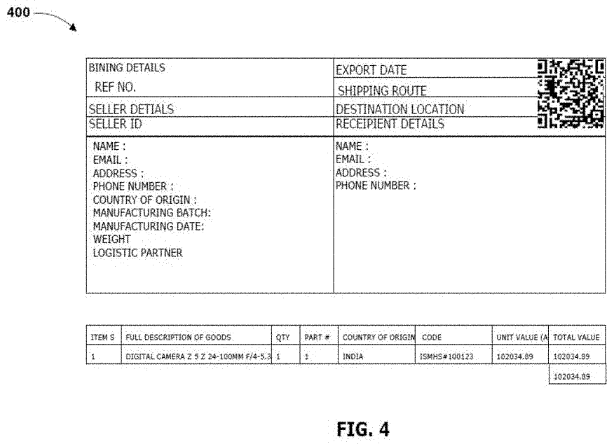

FIG. 4 illustrates an exemplary transfer document 400, in accordance to embodiment of the present disclosure. The transfer document may be tagged with QR code that may comprise encoded order information. Further, the transfer document may comprise detail of material (e.g., name, quantity, price, tax, category, country of origin, etc.), shipping or exporter/seller address, billing address (e.g., buyer address, bank detail etc.), seller details (e.g., name, address, contact detail), product details (e.g., manufacturing date, manufacturing batch, expiry date etc.), logistic details (e.g., contact detail of logistic partner), customs declaration, consignee/recipient details (e.g., name, address, address, company name, invoice number, date of export, quantity, country of origin, goods description, unique identification code, weight of package and product handling instruction (i.e., glass/fragile item—handle with care, food item store in cold item, pharmaceutical item—protect from light exposure etc.).

A number of implementations have been described. Nevertheless, various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors Executable instructions stored on the computer-readable media or memory can include, for example, an operating system, a data management framework , and/or other modules, programs, or applications that are loadable and executable by the processor(s) or any appropriate hardware logic components/CPU(s).

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

Conditional language such as, among others, include, “including”, “comprise”, “comprising”, “can,” “could,” “might” or “may,” unless specifically stated otherwise, is understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be any of X, Y, or Z, or a combination or sub-combination thereof. As described above, the exemplary embodiment provides both a method and corresponding apparatus consisting of various modules providing functionality for performing the steps of the method. The modules/engines may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments may be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

I/We claim:

1. A system to prepare a standardized transfer document for transportation of a material, the system comprises:
a server arrangement comprising:
a non-transitory storage device that is arranged to store a set of executable routines; and
a microprocessor which is coupled to the non-transitory storage device and operable to execute the set of routines to:
acquire, from a computing device through a buyer, a recipient detail, and an order detail to indicate intent of purchase of the material;
transmit, the acquired recipient detail and the acquired order detail to a computing machine, which is accessible by a supplier;
receive, from the computing machine, a transfer request from the supplier, wherein the transfer request comprises:
the received recipient detail;
the received order detail; and
an information of a carrier;
receive, a departure status from the carrier;
generate a quick response (QR) code, based on the received transfer request; and
prepare a standardized transfer document for transportation of the material, wherein the standardized transfer document is associated with the generated QR code.

2. The system of claim 1, wherein the server arrangement transmits the received departure status to the computing device.

3. The system of claim 2, wherein the server arrangement calculates and transmits an expected date of delivery of the material to the computing device, based on the received departure status and the received recipient detail.

4. The system of claim 1, wherein the server arrangement transmits the standardized transfer document and a corresponding QR code to the computing device.

5. The system of claim 4, wherein the server arrangement transmits a payment link with the standardized transfer document.

6. The system of claim 1, wherein the computing device receives a delivery update status from the buyer, upon delivery of the material.

7. The system of claim 6, wherein the server arrangement acquires the delivery update status from the computing device and updates the acquired delivery update status within the standardized transfer document.

8. A method for preparing a standardized transfer document for transportation of a material, the method comprises:
arranging a server arrangement for:
acquiring, from a computing device through a buyer, a recipient detail and an order detail to indicate intent of purchase of the material;
transmitting, the acquired recipient detail and the acquired order detail to a computing machine, which is accessible by a supplier;
receiving, from the computing machine, a transfer request from the supplier, wherein the transfer request comprises:
the received recipient detail;
the received order detail; and
an information of a carrier;
receiving, a departure status from the carrier;
generating a quick response (QR) code, based on the received transfer request; and
preparing a standardized transfer document for transportation of the material, wherein the standardized transfer document is associated with the generated QR code.

9. The method of claim 8, wherein the server arrangement transmits the received departure status to the computing device.

10. The method of claim 9, wherein the server arrangement calculates and transmits an expected date of delivery of the material to the computing device, based on the received departure status and the received recipient detail.

11. The method of claim 8, wherein the server arrangement transmits the standardized transfer document and a corresponding QR code to the computing device.

12. The method of claim 11, wherein the server arrangement transmits a payment link with the standardized transfer document.

13. The method of claim 8, wherein the computing device receives a delivery update status from the buyer, upon delivery of the material.

14. The method of claim 13, wherein the server arrangement acquires the delivery update status from the computing device and updates the acquired delivery update status within the standardized transfer document.

15. A non-transitory computer-readable storage medium, comprising executable instructions that, when executed by a processing system including a processor, facilitate preparing of a standardized transfer document for transportation of a material, comprising:
acquiring, from a computing device through a buyer, a recipient detail and an order detail to indicate intent of purchase of the material;
transmitting, the acquired recipient detail and the acquired order detail to a computing machine, which is accessible by a supplier;
receiving, from the computing machine, a transfer request from the supplier, wherein the transfer request comprises:
the received recipient detail;
the received order detail; and
an information of a carrier;
receiving, a departure status from the carrier;
generating a quick response (QR) code, based on the received transfer request; and
preparing, a standardized transfer document for transportation of the material, wherein the standardized transfer document is associated with the generated QR code.
